(19) United States
(12) Patent Application Publication
(10) Pub. No.: US 2024/0332672 A1
(43) Pub. Date: Oct. 3, 2024

(54) Battery Cell Cooling System for Electronic Vehicles

(71) Applicant: AVL Mobility Technologies, Inc., Plymouth, MI (US)

(72) Inventors: Christopher Meszaros, Brighton, MI (US); Mihally Gaspar, Many (HU); Peter Kurucz, Budapest (HU); Adam Dendrinos, Garden City, MI (US)

(21) Appl. No.: 18/615,120

(22) Filed: Mar. 25, 2024

Related U.S. Application Data
(60) Provisional application No. 63/454,761, filed on Mar. 27, 2023.

(51) Int. Cl. H01M 10/6568; H01M 10/613; H01M 10/625; H01M 10/6556; H01M 50/209; H01M 50/213; H01M 50/291

(52) U.S. Cl. CPC H01M 10/6568; H01M 10/613; H01M 10/625; H01M 10/6556; H01M 50/209; H01M 50/213; H01M 50/291; H01M 2220/20

(57) ABSTRACT

A battery cell cooling system includes a housing including an inlet configured to receive a coolant and an outlet configured to discharge the coolant, the housing defining a plurality of slots between the inlet and the outlet, each of the plurality of slots being spaced apart from adjacent slots, and a plurality of battery cells disposed in the plurality of slots, wherein the coolant is configured to flow from the inlet, through the spaces between plurality of slots, and to the outlet.

### CROSS REFERENCE TO RELATED APPLICATIONS

This application claims priority under 35 U.S.C. § 119 (e) to U.S. Provisional Application No. 63/454,761, filed on Mar. 27, 2023. The disclosure of this prior application is considered part of the disclosure of this application and is hereby incorporated by reference in its entirety.

### FIELD

The present disclosure relates generally to battery cell cooling systems for electronic vehicles.

### BACKGROUND

This section provides background information related to the present disclosure which is not necessarily prior art.

Electronic vehicles (EVs) include batteries comprising multiple cells. During operation of the EV, the battery cells generate heat due to enthalpy changes, electrochemical polarization, and resistive heating inside the cell. If there is insufficient cooling of the battery cells, then serious problems may arise, including decrease in battery performance, reduced cell life, thermal runaway, etc. Accordingly, there are opportunities for improvements in current battery cell cooling systems for EVs.

### SUMMARY

This section provides a general summary of the disclosure, and is not a comprehensive disclosure of its full scope or all of its features.

Implementations of the disclosure may include one or more of the following optional features. In some implementations, a battery cell cooling system includes a housing including an inlet configured to receive a coolant and an outlet configured to discharge the coolant, the housing defining a plurality of slots between the inlet and the outlet, each of the plurality of slots being spaced apart from adjacent slots, and a plurality of battery cells disposed in the plurality of slots, wherein the coolant is configured to flow from the inlet, through the spaces between plurality of slots, and to the outlet. This aspect may include one or more of the following optional features.

The coolant may directly contact the battery cells.

The battery cell cooling system may include a sleeve disposed in each of the plurality of slots, each sleeve being configured to receive one of the plurality of battery cells. The coolant may directly contact the sleeve, and heat may be transferred from the battery cell to the coolant through the sleeve. The battery cell cooling system may include thermal paste disposed between each battery cell and sleeve, and heat may be transferred from the battery cell to the coolant through the thermal paste and the sleeve.

The battery cell cooling system may include a seal configured to contain the coolant in the housing. The seal may be disposed around one of the battery cells to allow the coolant to directly contact the battery cell. The seal may extend around the periphery of the plurality of battery cells.

The battery cell cooling system may include a top coolant plate and a bottom coolant plate spaced from the top coolant plate, each of the coolant plates being configured to receive the plurality of battery cells. The coolant may be configured to be disposed between the top coolant plate and the bottom coolant plate. The battery cell cooling system may include a top securing plate spaced from the top coolant plate and a bottom securing plate spaced from the bottom coolant plate. Each of the plurality of battery cells may include a top lip configured to engage the top coolant plate and a bottom lip configured to engage the bottom coolant plate.

The coolant may be configured to contact the full circumference of each of the plurality of battery cells.

The battery cell cooling system may be configured to be incorporated into an electric vehicle.

The battery cell cooling system may be configured to be incorporated into a hybrid-electric vehicle.

The height of each of the plurality of battery cells may be greater than the height of each slot defined by the housing. Each of the plurality of battery cells may include a positive and negative terminal, and each positive and negative terminal may extend beyond the housing.

The coolant may be at least one of water, mono-ethylene glycol, and oil.

The plurality of sleeves may be cylindrical and the battery cells may be cylindrical.

The plurality of sleeves may be prismatic and the battery cells may be prismatic.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected configurations and not all possible implementations, and are not intended to limit the scope of the present disclosure.

FIG. 1 is a perspective view of a battery cooling system for EVs as set forth in the present disclosure;

FIG. 2 is a cross-sectional view of the battery cooling system of FIG. 1 taken along line 2-2;

FIG. 3 is a perspective view of the battery cooling system of FIG. 1 with the battery cells removed for visual clarity;

FIG. 4 is a cross-sectional view of the battery cooling system of FIG. 3 taken along line 4-4;

FIG. 5 is a perspective view of an alternative embodiment of a battery cooling system for EVs as set forth in the present disclosure;

FIG. 6 is a cross-sectional view of the battery cooling system of FIG. 5 taken along line 6-6;

FIG. 7 is a perspective view of an alternative embodiment of a battery cooling system for EVs as set forth in the present disclosure;

FIG. 8 is a cross-sectional view of an alternative embodiment of a battery cooling system for EVs as set forth in the present disclosure;

FIG. 9 is a perspective view of an alternative embodiment of a battery cooling system for EVs as set forth in the present disclosure;

FIG. 10A is a cross-sectional view of the battery cooling system of FIG. 9 taken along line 10-10; and FIG. 10B is a detailed view of a portion of FIG. 10A.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

As electric vehicles (EVs) continue to rise in popularity, one of the primary concerns with this type of automobile is ensuring the battery cells do not overheat, which can lead to the battery cells entering thermal runaway, a reduction in the performance of the battery cells, and/or a reduction in the lifetime of the battery cells. Compared to traditional automobiles having combustion engines, EVs need different cooling systems to ensure the battery cells do not overheat. Many cooling systems for EV batteries only target a small section of each battery cell, e.g., the bottom or partial side of each cell. Additionally, reducing the number of components between the battery cells and the coolant may improve heat transfer. However, when the coolant is a liquid, proper precautions must be taken to ensure certain portions of the battery cells remain isolated from the liquid coolant.

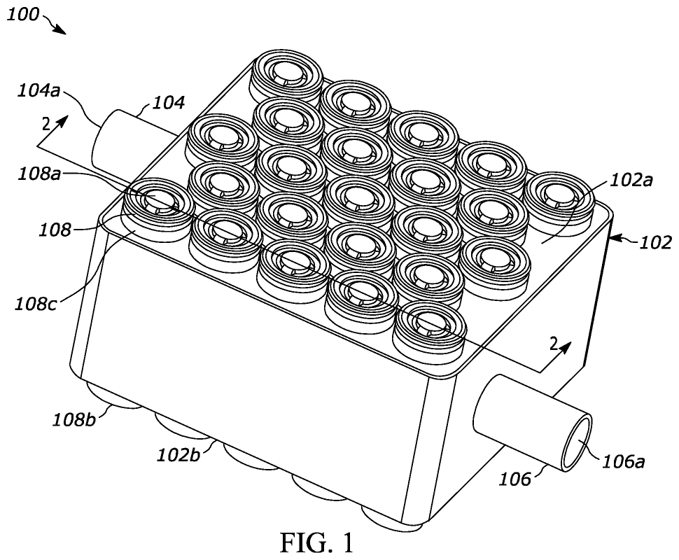

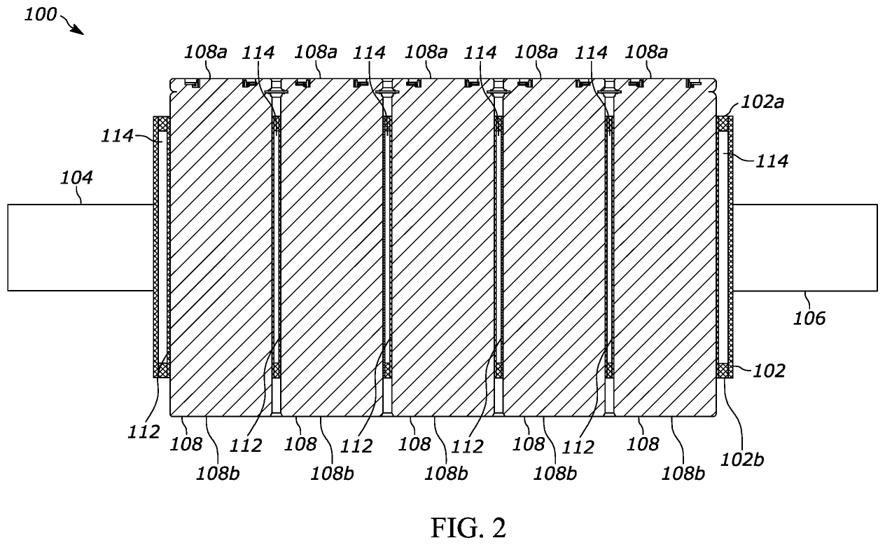

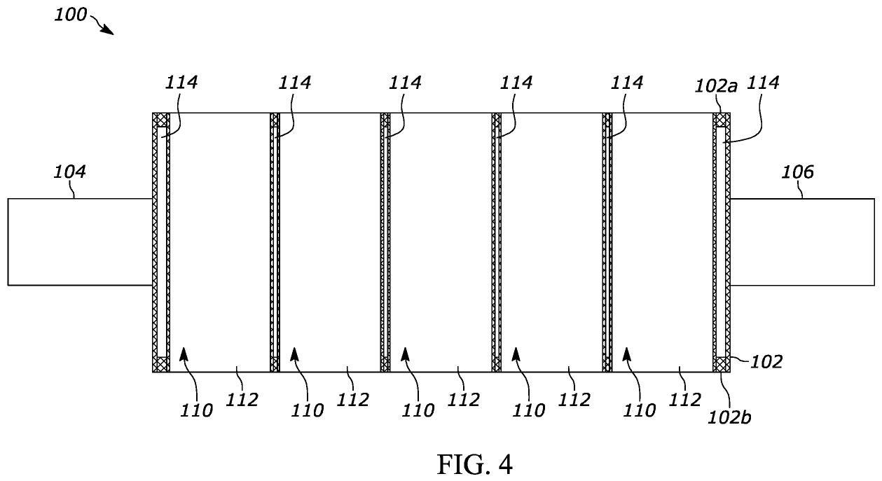

Referring to FIGS. 1-4, a cooling system 100 is generally shown. The cooling system 100 is configured to be installed in any suitable EV, including battery electric vehicles (BEVs), plug-in hybrid electric vehicles (PHEVs), and hybrid electric vehicles (HEVs). The cooling system 100 may also be configured for cylindrical and prismatic battery cells, although the figures only show cylindrical cells for illustrative purposes. The cooling system 100 includes a housing 102 having an inlet 104 and an outlet 106. The inlet 104 includes an inlet passage 104a configured to receive a coolant. Similarly, the outlet 106 includes an outlet passage 106a configured to discharge a coolant. The coolant may be any suitable coolant, including water, ethylene glycol, oil, air, aromatics (e.g., diethyl benzene), aliphatics (e.g., polyalphaolefins), silicones (e.g., silicone oil), fluorocarbons (e.g., hydrofluoroethers, perfluorocarbon ethers), liquid metals, nanofluid (e.g., CuO nanoparticles in EG/water), and any combination of the foregoing.

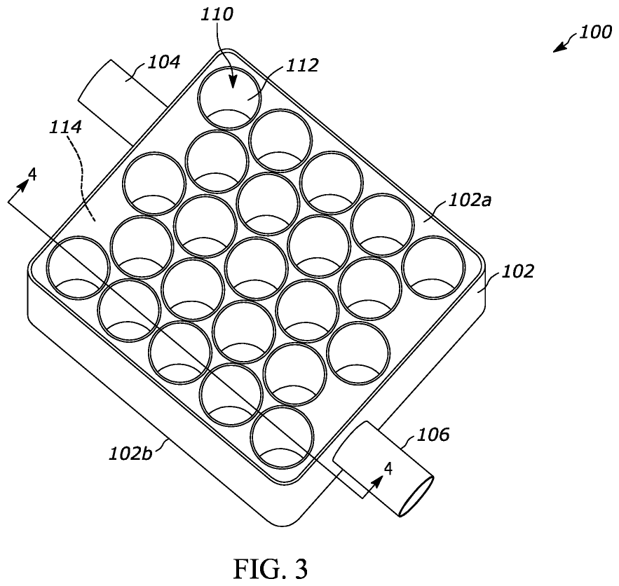

The housing 102 is configured to receive a plurality of battery cells 108. For example, as shown in FIG. 3, the housing 102 defines a plurality of slots 110 sized to receive the plurality of battery cells 108. In some implementations, each of the plurality of slots 110 receive a sleeve 112 that is sized to receive each of the battery cells 108. The sleeve 112 may be integrally formed with the housing 102 or may be formed separately and subsequently attached to the housing 102 via soldering, brazing, welding, or any other suitable process.

Each of the battery cells 108 includes a positive terminal 108a, a negative terminal 108b, and an outer surface 108c. As shown in FIG. 1, in some implementations, the positive terminal 108a extends beyond a top surface 102a of the housing 102 and the negative terminal 108b extends beyond a bottom surface 102b of the housing 102. There may be an intermediary material between the outer surface 108c of each battery cell 108 and each sleeve 112, such as glue, thermal paste, etc. The battery cells 108 may be any suitable shape, including cylindrical, prismatic (e.g., having a rectangular profile), etc. The battery cells 108 may be any suitable type of battery, including lithium-ion batteries, nickel-metal hydride batteries, lead-acid batteries, ultracapacitors, etc.

Referring to FIGS. 1-4, the housing 102 defines a cavity 114 between each of the battery cells 108 and completely surrounding each of the battery cells 108. That is, the complete circumference of each battery cell 108 is adjacent the cavity 114. The cavity 114 is configured to receive the coolant. By surrounding each individual battery cell 108, the coolant is able to contact a large surface area to increase heat transfer from the battery cells 108 to the coolant, thus improving performance and lifetime of the battery cells 108. Additionally, such a configuration may reduce the risks of thermal runaway.

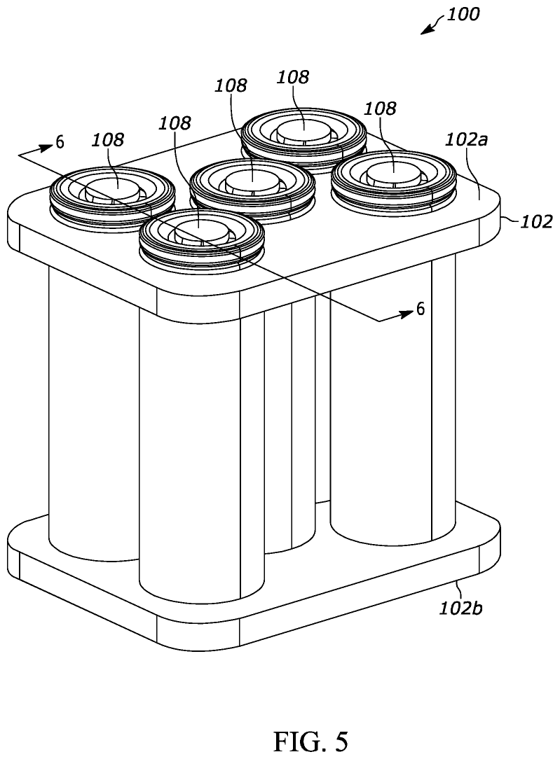

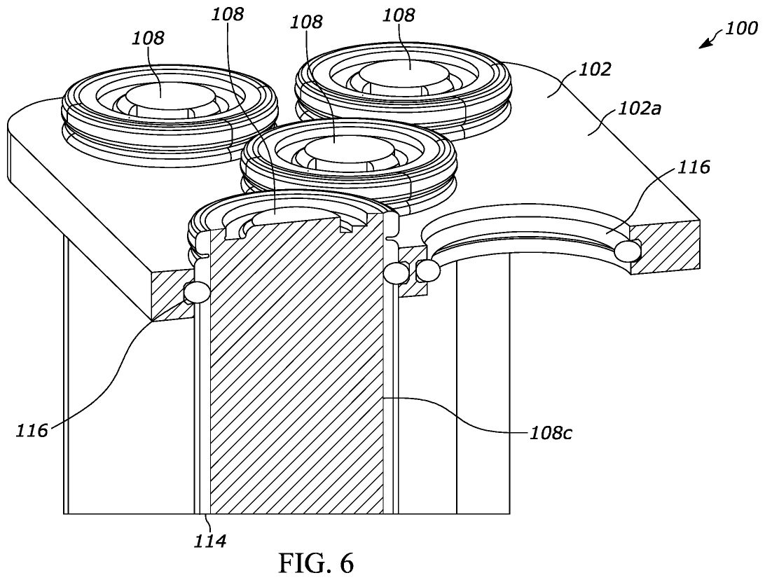

In alternative embodiments, for example, as shown in FIGS. 5 and 6, the sleeve 112 may be omitted and a seal 116 may be implemented at or near the top surface 102a and bottom surface 102b to create a seal at the outer surface 108c of each battery cell. The inlet 104 and the outlet 106 are omitted for clarity sake, and only a portion of the cooling system 100 is shown, but it should be understood that other features shown in FIGS. 1-4 are likewise present in this embodiment. The seal 116 and the outer surface 108c cooperate with the housing 102 to define the cavity 114 that receives the coolant. In these implementations, the coolant directly contacts the outer surface 108c of each battery cell 108. This further improves heat transfer from the battery cells 108 to the coolant as there are no obstructions between the battery cell 108 and the coolant.

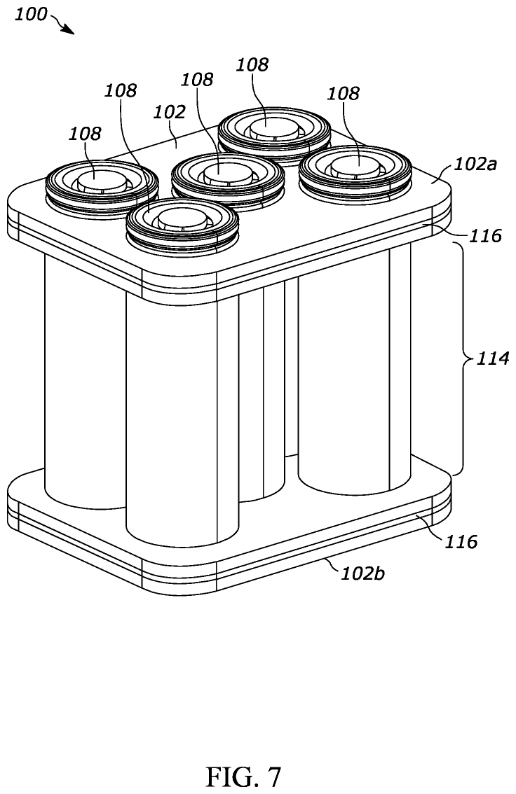

In another embodiment as shown in FIG. 7, the cooling system 100 includes a pair of seals 116 that extend around multiple battery cells 108. For example, the top seal 116 and the bottom seal 116 cooperate with the housing 102 to create a cavity that has an I-shaped profile with the top and bottom portions of the cavity 114 extending to the outer surface 108c of each battery cell 108 and to each seal 116, and the middle portion of the cavity 114 surrounding the outer surface 108c of the battery cells 108. The inlet 104 and the outlet 106 are omitted for clarity sake, and only a portion of the cooling system 100 is shown, but it should be understood that other features shown in FIGS. 1-4 are likewise present in this embodiment.

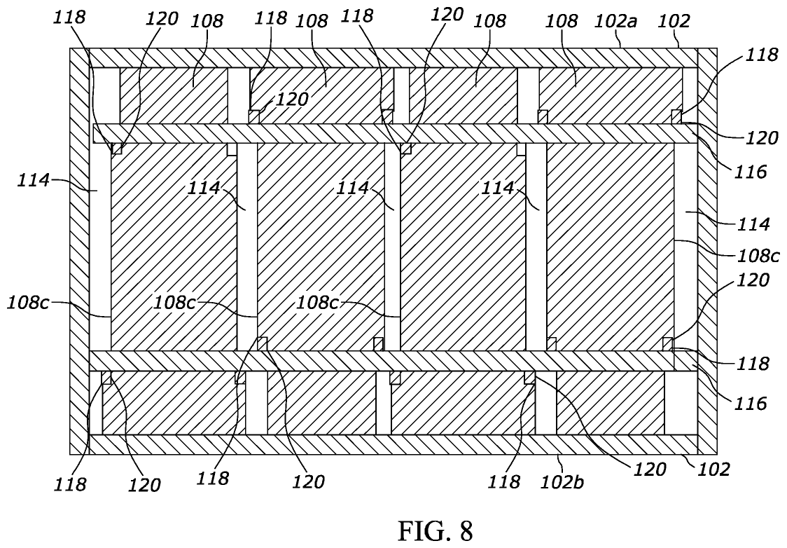

In another embodiment, as shown in FIG. 8, the battery cells 108 include a pair of steps or lips 118 that cooperate with the seals 116 to define the cavities 114 between the seals 116 and the outer surfaces 108c of the battery cells 108. The steps 118 are portions of the battery cells 108 that have a larger circumference or perimeter than the slots 110 that receive the battery cells 108. Additional seals 120 may be incorporated adjacent the steps 118 to ensure a proper seal is maintained. The inlet 104 and the outlet 106 are omitted for clarity sake, and only a portion of the cooling system 100 is shown, but it should be understood that other features shown in FIGS. 1-4 are likewise present in this embodiment.

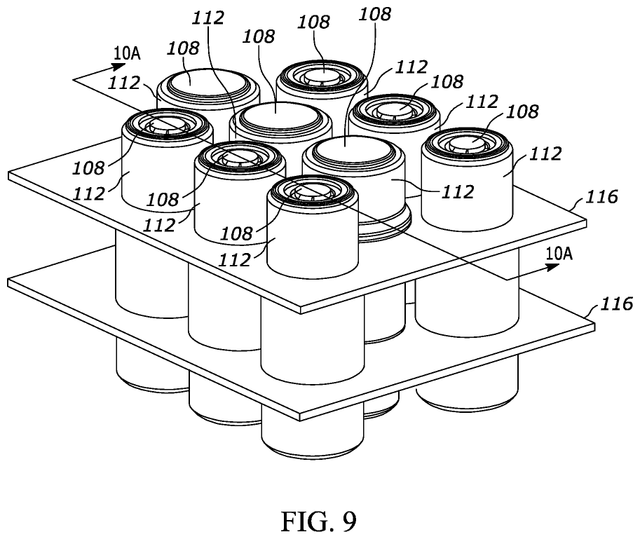

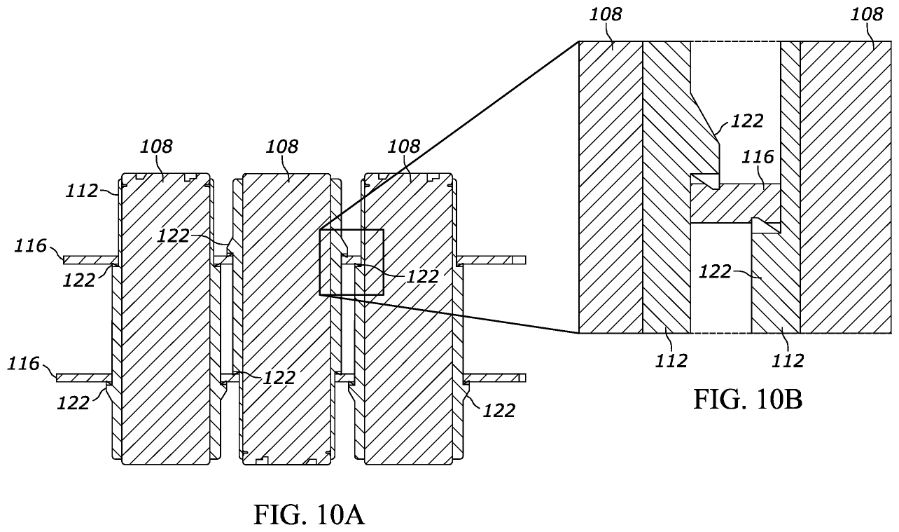

In another embodiment, as shown in FIGS. 9 and 10, the battery cells 108 may be received in sleeves 112 that include steps or lips 122 that engage a top seal 116 and a bottom seal 116 similar to the embodiment shown in FIG. 8. The sleeves 112 may be formed of a polymer with additives to help with heat transfer. In some implementations, the seals 116 may be over-molded directly to the lip 122 with silicone or other suitable material to create a suitable seal as shown in FIG. 10B. The inlet 104 and the outlet 106 are omitted for clarity sake, and only a portion of the cooling system 100 is shown, but it should be understood that other features shown in FIGS. 1-4 are likewise present in this embodiment.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms first, second, third, etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed above could be termed a second element, component, region, layer or section without departing from the teachings of the example configurations.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A battery cell cooling system, comprising:
a housing including an inlet configured to receive a coolant and an outlet configured to discharge the coolant, the housing defining a plurality of slots between the inlet and the outlet, each of the plurality of slots being spaced apart from adjacent slots; and
a plurality of battery cells disposed in the plurality of slots;
wherein the coolant is configured to flow from the inlet, through the spaces between plurality of slots, and to the outlet.

2. The battery cell cooling system of claim 1, wherein the coolant directly contacts the battery cells.

3. The battery cell cooling system of claim 1, further comprising a sleeve disposed in each of the plurality of slots, each sleeve being configured to receive one of the plurality of battery cells.

4. The battery cell cooling system of claim 3, wherein the coolant directly contacts the sleeve, and wherein heat is transferred from the battery cell to the coolant through the sleeve.

5. The battery cell cooling system of claim 4, further comprising thermal paste disposed between each battery cell and sleeve, and wherein heat is transferred from the battery cell to the coolant through the thermal paste and the sleeve.

6. The battery cell cooling system of claim 1, further comprising a seal configured to contain the coolant in the housing.

7. The battery cell cooling system of claim 6, wherein the seal is disposed around one of the battery cells to allow the coolant to directly contact the battery cell.

8. The battery cell cooling system of claim 6, wherein the seal extends around the periphery of the plurality of battery cells.

9. A battery cell cooling system, comprising:
a housing including an inlet configured to receive a coolant and an outlet configured to discharge the coolant, the housing defining a plurality of slots between the inlet and the outlet, each of the plurality of slots being spaced apart from adjacent slots;
a plurality of battery cells disposed in the plurality of slots; and
a top coolant plate and a bottom coolant plate spaced from the top coolant plate, each of the coolant plates being configured to receive the plurality of battery cells;
wherein the coolant is configured to flow from the inlet, through the spaces between plurality of slots, and to the outlet.

10. The battery cell cooling system of claim 9, wherein the coolant is configured to be disposed between the top coolant plate and the bottom coolant plate.

11. The battery cell cooling system of claim 9, further comprising a top securing plate spaced from the top coolant plate and a bottom securing plate spaced from the bottom coolant plate.

12. The battery cell cooling system of claim 9, wherein each of the plurality of battery cells include a top lip configured to engage the top coolant plate and a bottom lip configured to engage the bottom coolant plate.

13. The battery cell cooling system of claim 9, wherein the coolant is configured to contact the full circumference of each of the plurality of battery cells.

14. The battery cell cooling system of claim 9, wherein the battery cell cooling system is configured to be incorporated into an electric vehicle.

15. The battery cell cooling system of claim 9, wherein the battery cell cooling system is configured to be incorporated into a hybrid-electric vehicle.

16. A battery cell cooling system, comprising:
a housing including an inlet configured to receive a coolant and an outlet configured to discharge the coolant, the housing defining a plurality of slots between the inlet and the outlet, each of the plurality of slots being spaced apart from adjacent slots; and
a plurality of battery cells disposed in the plurality of slots;
wherein the coolant is configured to flow from the inlet, through the spaces between plurality of slots, and to the outlet; and
wherein the height of each of the plurality of battery cells is greater than the height of each slot defined by the housing.

17. The battery cell cooling system of claim 16, wherein each of the plurality of battery cells includes a positive and negative terminal, and each positive and negative terminal extends beyond the housing.

18. The battery cell cooling system of claim 16, wherein the coolant is at least one of water, mono-ethylene glycol, and oil.

19. The battery cell cooling system of claim 16, wherein the plurality of sleeves are cylindrical and the battery cells are cylindrical.

20. The battery cell cooling system of claim 16, wherein the plurality of sleeves are prismatic and the battery cells are prismatic.
